(19) United States
(12) Patent Application Publication
(10) Pub. No.: US 2024/0242066 A1
(43) Pub. Date: Jul. 18, 2024

(54) ANALOG ONLINE LEARNING CIRCUIT

(71) Applicant: THE OPEN UNIVERSITY, Raanana (IL)

(72) Inventors: Elishai Ezra TSUR, Jerusalem (IL); Avi HAZAN, Kfar Saba (IL)

(73) Assignee: THE OPEN UNIVERSITY, Raanana (IL)

(21) Appl. No.: 18/289,470

(22) PCT Filed: May 4, 2022
(86) PCT No.: PCT/IL2022/050473

§ 371 Date: Nov. 3, 2023

Related U.S. Application Data
(60) Provisional application No. 63/183,925, filed on May 4, 2021.

(51) Int. Cl. G06N 3/065; G06N 3/049

(52) U.S. Cl. CPC G06N 3/065; G06N 3/049

(57) ABSTRACT

An analog signal processing circuit for generating a component signal for a feedback signal of an artificial neuron circuit comprising an input stage configured to receive and adapt an output signal of the artificial neuron circuit a first multiplier circuit configured to generate a first product signal based on a multiplication of the adapted output signal by a previously generated feedback signal of the artificial neuron circuit, a weight update circuit configured to generate a new weight signal based on a multiplication of a previously generated weight signal of the analog signal processing circuit by a summation of the previously generated weight signal with the first product signal; and a second multiplier circuit configured to generate the signal component as a second product signal based on a multiplication of the output signal by the new weight signal.

### TECHNOLOGICAL FIELD

The present invention is generally in the field of neural networks, such as implemented based on the neural engineering framework (NEF).

### BACKGROUND ART

References considered to be relevant as background to the presently disclosed subject matter are listed below:
[1] S. Olkowicz, M. Kocourek, R. K, a. P. M. Lucan, W. T. Fitch, S. Herculano-Houzel and P. Nemec, “Birds have primate-like numbers of neurons in the forebrain,” Proceedings of the National Academy of Sciences, vol. 113, no. 26, pp. 7255-7260, 2016.
[2] D. Palossi, A. Loquercio, F. Conti, E. Flamand, D. Scaramuzza and L. Benini, “Ultra-low power deep-learning-powNered autonomous nano drones,” in IEEE/RSJ International Conference on Intelligent Robots and Systems, 2018.
[3] G. I. Parisi, R. Kemker, J. L. Part, C. KanIan and S. Wermter, “Continual lifelong learning with neural networks: A review,” Neural Networks, vol. 113, pp. 54-71, 2019.
[4] K. Kouvaris, J. Chine, L. Kounios, M. Brede and R. A. Watson, “How evolution learms to generalise: Using the principles of learning theory to understand the evolution of developmental organisation,” PLoS computational biology, vol. 13, no. 4, p. e1005358, 2017.
[5] D. Markovic, A. Mizrahi, D. Querlioz and J. Grollier, “Physics for neuromorphic computing,” Nature Reviews Physics, vol. 2, no. 9, pp. 499-510, 2020.
[6] M. V. DeBole, B. Taba, A. Amir, F. Akopyan, A. Andreopoulos, W. P. Risk, J. Kusnitz, C. O. Otero, T. K. A. R. Navak and e. al, “TrueNorth: Accelerating from zero to 64 million neurons in 10 years,” Computer, vol. 52, no. 5, pp. 20-29, 2019.
[7] M. Davies, N. Srinivasa, T.-H. Lin, G. Chinya, Y. Cao, S. H. Choday, G. Dimou, P. Joshi, N. Imim, S. Jain and e. al, “Loihi: A neuromorphic manycore processor with on-chip learning,” IEEE Micro. vol. 38, no. 1, pp. 82-99, 2018.
[8] B. V. Benjamin, P. Gao, E. McQuinn, S. Choudhary, A. Chandrasekaran, J.-M. Bussat, R. Alvarez-Icaza, J. Arthur, P. A. Merolla and K. Boahen, “Neurogrid: A mixed-analog-digital multichip system for large-scale neural simulations,” Proceedings of the IEEE, vol. 102, no. 5, pp. 699-716, 2014.
[9] S. Furber, F. Galluppi, S. Temple and L. A. Plana, “The spinnaker project,” Proceedings of the IEEE, vol. 102, no. 5, pp. 652-665, 2014.
[10] A. Neckar, S. Fok, B. V. Benjamin, T. C. Stewart, N. N. Oza, A. R. Voelker, C. Eliasmith, R. Manohar and K. Boahen, “Braindrop: A mixed-signal neuromorphic architecture with a dynamical systens-based programming model,” Proceedings of the IEEE, vol. 107, no. 1, pp. 144-164, 2018.
[11] C. Eliasmith and C. H. Anderson, Neural engineering: Computation, representation, and dynamics in neurobiological systems. MIT press, 2004.
[12] E. E. Tsur and M. Rivlin-Etzion, “Neuromorphic implementation of motion detection using oscillation interference,” Neurocomputing, vol. 374, pp. 54-63, 2020.
[13] Y. Zaidel, A. Shalumov, A. Volinski, L. Supic and E. E. Tsur, “Neuromorphic NEF-based inverse kinematics and PID control,” Frontiers in Neurorobotics, vol. 15, 2021.
[14] A. Hazan and E. Ezra Tsur, “Neuromorphic Analog Implementation of Neural Engineering Framework-Inspired Spiking Neuron for High-Dimensional Representation,” Frontiers in Neuroscience, vol. 15, p. 109, 2021.
[15] T. Bekolay, J. Bergstra, E. Hunsberger, T. DeWolf, T. Stewart, D. Rasmussen, X. Choo, A. Voelker and C. Eliasmith, “Nengo: a Python tool for building large-scale functional brain models,” Frontiers in neuroinformatics, vol. 7, no. 1, p. 48, 2014.
[16] A. Voelker, I. Kajid and C. Eliasmith, “Legendre Memory Units: Continuous-Time Representation in Recurrent Neural Networks,” in Advances in Neural Information Processing Systems, 2019.
[17] C.-K. Lin, A. Wild, G. Chinya, Y. Cao, M. Davies, D. M. Lavery and H. Wang, “Programming spiking neural networks on intel's loihi,” Computer, vol. 51, no. 3, pp. 52-61, 2018.
[18] K. Boahen, “A neuromorph's prospectus,” Computing in Science & Engineering, vol. 19, no. 2, pp. 14-28, 2017.
[19] A. R. Voelker, “A solution to the dynamics of the prescribed error sensitivity learning rule,” Centre for Theoretical Neuroscience, Waterloo, 2015.
[20] A. Devices, “LTspice simulator,” 2008. [Online]. Available: http://www.analog.com/en/design-center/design-tools-and-calculators/ltspice-simulator.htmn. [Accessed 26 9 2020].
[21] L. Nagel and D. Pederson, “SPICE (simulation program with integrated circuit emphasis),” University of California, Berkeley, 1973.
[22] K. Nichols, T. Kaznmierski, M. Zwolinski and A. Brown, “Overview of SPICE-like circuit simulation algorithms,” IEE Proceedings-Circuits, Devices and Systems, vol. 141, no. 4, pp. 242-250, 1994.
[23] C. Eliasinth, How to build a brain: A neural architecture for biological cognition, Oxford University Press, 2013.
[24] A. B. Research, “nengo.ai,” [Online]. Available: https://www.nengo.ai/nengo-loihi/v0.9.0/examples/learn_communication_channel.html. [Accessed 26 3 2021].
[25] K. Fischli, A. Andreou, T. Stewart and K. Fair, “Implementation of the neural engineering framework on the TrueNorth neurosynaptic system,” in IEEE Biomedical Circuits and Systems Conference (BioCAS). 2018.
[26] A. Mundy, J. S. T. Knight and S. Furber, “An efficient SpiNNaker implementation of the neural engineering framework,” in International Joint Conference on Neural Networks (IJCNN), 2015.
[27] G. Indiveri and R. Douglas, “Neuromorphic vision sensors,” Science, vol. 288, no. 5469, pp. 1189-1190, 2000.
[28] S.-C. Liu and T. Delbruck, “Neuromorphic sensory systems,” Current opinion in neurobiology, vol. 20, no. 3, pp. 288-295, 2010.
[29] E. E. Tsur, Neuromorphic Engineering: The Scientist's, Algorithm Designer's, and Computer Architect's Perspectives on Brain-Inspired Computing, CRC Press, 2021.
[30] T. Bekolay, J. Bergstra, E. H-unsberger, T. DeWolf, T. Stewart, D. Rasmussen, X. Choo, A. Voelker and C. Eliasmith, “Nengo: a Python tool for building large-scale functional brain models,” Frontiers in neuroinforinatics, vol. 7, no. 1, p. 48, 2014.
[31] S. Mittal, “A survey of architectural techniques for managing process variation,” ACM Computing Surveys (CSUR), vol. 48, no. 4, pp. 1-29, 2016.
[32] A. R. Lanfranco, A. E. Castellanos, J. P. Desai and W. C. Meyers, “Robotic surgery: a current perspective,” Annals of surgery, vol. 239, no. 1, p. 14, 2004.
[33] S.-I, Nishida, S. Kawamoto, Y. Okawa, F. Terui and S. Kitamura, “Space debris removal system using a small satellite,” Acta Astronautica, vol. 65, no. 102, pp. 95-102, 2009.
[34] T. DeWolf, T. C. Stewart, J.-J. Slotine and C. Eliasminth, “A spiking neural model of adaptive arm control,” Proceedings of the Royal Society B: Biological Sciences, vol. 283, no. 1843, p. 20162134, 2016.
[35] S.-C. Liu, T. Delbruck, G. Indiveri, A. Whatley and R. Douglas, Event-based neuromorphic systems, John Wiley & Sons, 2014.
[36] J. L. Krichmar and H. Wagatsuma, Neuromorphic and brain-based robots, Cambridge University Press, 2011.
[37] W. Zhang, B. Gao, J. Tang., P. Yao, S. Yu, M.-F. Chang, HA. Yoo, H. Qian and H. Wu, “Neuro-inspired computing chips,” Nature Electronics, vol. 3, no. 7, pp. 371-382, 2020.
[38] O. Krestinskaya, James, A. Pappachen and L. Chua, “Neuromemristive circuits for edge computing: A review,” IEEE transactions on neural networks and learning systems, vol. 31, no. 1, pp. 4-23, 2019.
[39] C. Eliasmith and C. H. Anderson, Neural engineering: Computation, representation, and dynamics in neurobiological systems, MIT press, 2003.
[40] T. DeWolf, P. Jaworski and C. Eliasmith, “Nengo and low-power AI hardware for robust, embedded neurorobotics,” arXiv preprint arXiv:2007.10227, 2020.
[41] C. Eliasmith, T. C. Stewart, X. Choo, T. Bekolay, T. DeWolf, Y. Tang and D. Rasmussen, “A large-scale model of the functioning brain,” science, vol. 338, no. 6111, pp. 1202-1205, 2012.
[42] R. Wang, C. S. Thakur, G. Cohen, T. J. Hamilton, J. Tapson and A. van Schaik, “Neuromorphic hardware architecture using the neural engineering framework for pattern recognition,” IEEE transactions on biomedical circuits and systems, vol. 11, no. 3, pp. 574-584, 2017.
[43] G. Indiveri, B. Linares-Barranco, T. J. Hamilton, A. Van Schaik, R. Etienne-Cummings, T. Delbnick, S.-C. Liu, P. Dudek, P. Hafliger, S. Renaud and e. al, “Neuromorphic silicon neuron circuits,” Frontiers in neuroscience, vol. 5, p. 73, 2011.
[44] C. Mayr, J. Partzsch, M. Noack and R. Schuffnv, “Configurable analog-digital conversion using the neural engineering framework,” Frontiers in neuroscience, vol. 8, p. 201, 2014.
[45] A. Burkitt, “A review of the integrate-and-fire neuron model: I. Homogeneous synaptic input,” Biological cybernetics, vol. 95, no. 1, pp. 1-19, 2006.
[46] T. Stewart and C. Eliasmith, “Large-scale synthesis of functional spiking neural circuits,” Proceedings of the IEEE, vol. 102, no. 5, pp. 881-898, 2014.
[47] C. Mead, Analog VLSI and neural systems, Addison-Wesley Longman Publishing, 1989.
[48] P. Merolla and K. Boahen, “A recurrent model of orientation maps with simple and complex cells,” in Advances in neural information processing systems, 2004.
[49] C. Bartolozzi and G. Indiveri, “Synaptic dynamics in analog VLSI,” Neural computation, vol. 19, no. 10, pp. 2581-2603, 2007.
[50] A. Van Schaik, “Building blocks for electronic spiking neural networks,” Neural networks, vol. 6, no. 14, pp. 617-628, 2001.
[51] A. Amara, F. Amiel and T. Ea, “FPGA vs. ASIC for low power applications,” Microelectronics journal, vol. 37, no. 8, pp. 669-677, 2006.
[52] S. Yang, J. Wang, Q Lin, B. Deng, X. Wei, C. Liu and H. Li, “Cost-efficient FPGA implementation of a biologically plausible dopamine neural network and its application,” Neurocomputing, vol. 314, pp. 394-408, 2018.
[53] S. Yang, J. Wang, B. Deng, C. Liu, H. Li, C. Fietkiewicz and K. A. Loparo, “Real-time neuromorphic system for large-scale conductance-based spiking neural networks,” IEEE transactions on cybernetics, vol. 49, no. 7, pp. 2490-2503, 2018.
[54] S. Yang, B. Deng, J. Wang, H. Li, M Lu, Y. Che, X. Wei and K. A. Loparo, “Scalable digital neuromorphic architecture for large-scale biophysically meaningful neural network with multi-compartment neurons,” IEEE transactions on neural networks and learning systems, vol. 31, no. 1, pp. 148-162, 2019.
[55] C. Eliasmith and O. Trujillo, “The use and abuse of large-scale brain models.” Current Opinion in Neurobiology, vol. 25, pp. 1-6, 2014.
[56] S. A. Aamir, P. Muller, L. Kilener, G. Kiene, J. Schemmel and K. Meier, “From LIF to AdEx neuron models: Accelerated analog 65 nm CMOS implementation,” in IEEE Biomedical Circuits and Systems Conference (BioCAS), 2017.
[57] A. Tripathri, M. Arabizadeh, S. Khandelwal and C. S. Thakur, “Analog Neuromorphic System Based on Multi Input Floating (Gate MOS Neuron Model,” in IEEE International Symposium on Circuits and Systems (ISCAS), 2019.
[58] L. Ankri, E. Ezra-Tsur, S. R. Maimon, N. Kaushansky and M. Rivlin-Etzion, “Antagonistic center-surround mechanisms for direction selectivity in the retina,” Cell Reports, vol. 31, no. 5, p. 107608, 2020.
[59] J. Gosmann and C. Eliasmith, “Optimizing semantic pointer representations for symbol-like processing in spiking neural networks,” PloS one, vol. 11, no. 2, p. e0149928, 2016.

### BACKGROUND

This section intends to provide background information concerning the present application, which is not necessarily prior art.

While proven incredibly valuable for numerous applications, ranging from robotics and medicine to economy and computational cognition, artificial intelligence (AI), in many ways, is nullified when compared with biological intelligence. For example, the Cockatiel Parrot's can navigate and learn unknown environments at 35 km/hr, manipulate objects and learn to use human language, with a brain consuming merely 50 mW of power [1]. Comparably an autonomous drone with comparable mass and size consumes 5,000 mW of power while being limited to pretrained flying in a known environment with limited capacity for real-time learning [2]. Deep learning with artificial neural networks (ANN) is a predominantly method in AI. ANNs, however, are limited to slow generalization with massive data, offline training, and batched optimization [3]. In contrast, biological learning is characterized by a fast generalization and online, incremental learning [4].

Spiking Neural Networks (SNN) closely follow the computational characteristics of biological learning, and stand as a new frontier of AI [29]. SNNs may comprise densely connected, physically implemented “silicon neurons,” which communicate with spikes [5]. SNNs were realized in various hardware designs, including IBM's TrueNorth [6], Intel's Loihi [7], the NeuroGrid [8], the SpiNNaker [9], and the BrainDrop [10].

Neuromorphic hardware designs realize neural principles in analog electronic circuitries to provide high-performing, energy-efficient frameworks for machine learning. Programming a neuromorphic system is a challenging endeavor, as it requires the ability to represent data, manipulate and retrieve it with spike-based computing. One theoretical framework designed to address these challenges is the neural engineering framework (NEF) [11]. NEF brings forth a theoretical framework for representing high-dimensional mathematical constructs with spiking neurons for the implementation of functional large-scale neural networks. It was used to design abroad spectrum of neuromorphic systems ranging from vision processing [12] to robotic control [13]. NEF was compiled to work on each of the neuromorphic hardware designs listed above [14] via Nengo, a Python-based “neural compiler,” which translates high-level descriptions to low-level neural models [15].

One of the most promising directions for neuromorphic systems is real-time continuous learning [5]. A neuromorphic continuous learning framework was recently shown to handle temporal dependencies spanning 100,000 time-steps, converge rapidly, and use few internal state-variables to learn complex functions spanning long windows of time, outperforming state-of-the-art ANNs [16]. Neuromorphic systems, however, can realize their full potentials only when deployed on neuromorphic hardware.

### GENERAL DESCRIPTION

The present application provides neuromorphic analog designs for continuous real-time learning, which can be implemented in integrated circuits e.g., on a chip. Hardware designs of the embodiments disclosed herein realizes the underlying principles of the Neural Engineering Framework (NEF). NEF brings forth a theoretical framework for the representation and transformation of mathematical constructs with spiking neurons. Thus, providing efficient means for neuromorphic machine learning and the design of intricate dynamical systems. Analog circuits of embodiments disclosed herein implements the neuromorphic prescribed error sensitivity (PES) learning rule with spiking neurons, such as the OZ analog spiking neuron [14], which was shown to have full correspondence with NEF across firing rates, encoding vectors, and intercepts. The present application demonstrates PES-based neuromorphic representation of mathematical constructs with varying neuron configurations, the transformation of mathematical constructs, and the construction of a dynamical system with the design of an inducible leaky oscillator.

Neuromorphic Representation with NEF

NEF brings forth a theoretical framework for neuromorphic encoding of mathematical constructs with spiking neurons, allowing for the implementation of functional large-scale neural networks [11]. It provides a computational framework with which information, given in terms of vectors and functions, can be transformed into a set of interconnected ensembles of spiking neurons. In NEF, spikes train δᵢ of neuron i (where 1≤i≤N is an integer) in response to stimulus x is defined as follows:

$${δ}_{i} ( x ) = {G}_{i} [ {α}_{i} {e}_{i} + {J}_{i}^{b} ] , \qquad ( 1 )$$

where Gᵢ is a spiking neuron model, αᵢ is a gain term, eᵢ is the neuron's preferred stimulus (encoding vector) and Jᵢ^{b} is a fixed background current. An ensemble of neurons can encode a high-dimensional vector, which can be linearly decoded as \hat{x} according to the following expression:

$$\hat{x} = {Σ}_{i}^{N} {a}_{i} ( x ) {d}_{i} , \qquad ( 2 )$$

where N is the number of neurons, aᵢ(x) is the postsynaptic low-pass filtered response of neuron i to stimulus x and dᵢ is a linear decoder that was optimized to reconstruct x using least squared optimization. Neuron's postsynaptic response can be defined as follows:

$${a}_{i} ( x ) = Σ {h}_{i} ⋆ {δ}_{i} ( t - {t}_{j} ( x ) ) , \qquad ( 3 )$$

where hᵢ is the synaptic response function (usually an exponential with a time constant determined by the neurotransmitter type at the synapse), “*” is the convolution operator, and δᵢ(t−tⱼ(x)) is the spike train produced by neuron i in response to stimulus x, with spike times indexed by j (where j is a positive integer).

Importantly, when representation is distributively realized with spiking neurons, the number of neurons dramatically affects performance and stability. This is referred to as decoder-induced static noise S_{N}, and it is proportional to the number of neurons N according to the expression:

$${S}_{N} \sim 1 / {N}^{2} \qquad ( 4 )$$

Neuromorphic Transformation with NEF

Equations (1) and (2) describe how vectors are encoded and decoded using neural spiking activity in neuronal ensembles. Propagation of data from one ensemble to another is realized through weighted synaptic connections, formulated with a weight matrix. The resulting activity transformation is a function of x. Notably, it was shown that any function ƒ(x) could be approximated using some set of decoding weights d^{f} [11]. Defining ƒ(x) in NEF can be made by connecting two neuronal ensembles A and B via neural connection weights wᵢⱼ(x), which can be defined as follows:

$${w}_{ij} = {d}_{i} ⊗ {e}_{j} , \qquad ( 5 )$$

where i is the neuron index in ensemble A, j is the neuron index in ensemble B, dᵢ are the decoders of ensemble A, which were optimized to transform x to ƒ(x), eⱼ are the encoders of ensemble B, which represents ƒ(x) and ⊗ is the outer product operation.

### Prescribed Error Sensitivity

Connection weights, which govern the transformation between one representation to another, can also be adapted or learned in real-time, rather than optimized during model building. Weights adaptation in real-time is of particular interest in AI, where unknown perturbations can affect the error. One efficient way to implement real-time learning with NEF is using the prescribed error sensitivity (PES) learning rule. PES is a biologically plausible supervised learning rule that modifies a connection's decoders d to minimize an error signal e. The error signal e is calculated as the difference between the stimulus and its approximated representation: \hat{x}−x. The PES applies the following update rule:

$$Δ d = λ e δ , \qquad ( 6 )$$

where λ is the learning rate. Notably, it was shown that when a−λ∥δ∥² (denoted γ) is larger than −1, the error e goes to 0 exponentially with rate γ. PES is described at length in [19].
Neuromorphic Dynamics with NEF

System dynamics is a theoretical framework concerning the nonlinear behaviour of complex systems over time. Dynamics is the third fundamental principle of NEF, and it provides the framework for using SNNs to solve differential equations. It is essentially a combination of the first two NEF principles: representation and transformation, where transformation is used in a recurrent scheme. A recurrent connection (connecting a neural ensemble back to itself) can be defined as follows: x(t)=ƒ(x(t))*h(t). A canonical description of a linear error-correcting feedback loop can be expressed by:

$$\frac{dx}{dt} = Ax ( t ) + Bu ( t ) ,$$

where x(t) is a state vector, which summarizes the effect of all past inputs, u(t) is the input vector, B is the input matrix, and A is the dynamic matrix. In NEF, this standard control can be realized by using:

$$\frac{dx}{dt} = {A}^{′} x ( t ) + {B}^{′} u ( t ) , \qquad ( 7 )$$

where A′ is the recurrent connection matrix, which is defined as τA+I, where I is the identity matrix, τ is the synapse decaying time constant, and B′ is the input connection matrix, which is defined as τB.

An oscillator is a fundamental dynamical system. A two-dimensional (2D) oscillator, which alternates the values of x₁ and x₂, at a rate r, can be defined recurrently as follows:

$$( \begin{matrix}{x}_{1} \\ {x}_{2}\end{matrix} ) = ( \begin{matrix}1 & r \\ - r & 1\end{matrix} ) ( \begin{matrix}{x}_{1} \\ {x}_{2}\end{matrix} ) = Ax . \qquad ( 8 )$$

In order to achieve an oscillatory dynamic in which

$$\frac{{dx}_{1}}{dt} = r {x}_{2} and \frac{{dx}_{2}}{dt} = - {rx}_{1} ,$$

it is possible to define the following recurrent connections: x₁=x₁ₚᵣₑ+x₂ and x₂=x₂ₚᵣₑ−x₁, achieving

$${x}_{1} = ( \frac{r}{τ} ) {x}_{2} and {x}_{2} = ( \frac{- r}{τ} ) {x}_{1} .$$

Implementing this model without inducing some initial value x₁ or x₂, will result in a silent oscillator i.e., it will stand still at (0,0). However, when a stimulus is applied—even a very short stimulus—the oscillator is driven to oscillate indefinitely. A leaky oscillator can be defined by introducing K as a dumping factor, as follows:

$$( \begin{matrix}{x}_{0} \\ {x}_{1}\end{matrix} ) = ( A - κ I ) ( \begin{matrix}{x}_{0} \\ {x}_{1}\end{matrix} ) , \qquad ( 9 )$$

where I is the identity matrix.

In a broad aspect there is provided an analog learning system comprising: two or more analog learning cores, each analog learning core configured to produce an output signal based on a respective neuron signal thereof and a factoring (error) term signal; a summation unit configured to generated a summation signal based on summation of the output signals from the two or more learning cores; and a factor generator circuit configured to generate the factoring term signal based on the summation signal. Each of the two or more learning cores comprising: an analog neuron circuit configured to generate the respective neuron signal responsive to one or more input signals and respective one or more scaling (weight) signals; and an analog learning block (also referred to herein as learning core) configured to adjust at least one of said one or more scaling signals based on the respective neuron signal and a predefined adaptation signal indicative of a learning rate of the system.

One inventive aspect disclosed herein relates to an analog signal processing circuit for generating a component signal for a feedback signal of an artificial neuron circuit/network or its learning core(s). The analog signal processing circuit comprising an input stage configured to receive and adapt an output signal of said artificial neuron circuit, a first multiplier circuit configured to generate a first product signal indicative/based on of multiplication of the adapted output signal by a previously generated feedback signal of said artificial neuron circuit/network or its learning core(s), a weight update circuit configured to generate a new weight signal based on a multiplication of a previously generated weight signal of said analog signal processing circuit by a summation of the previously generated weight signal with the first product signal, and a second multiplier circuit configured to generate said signal component as a second product signal based on a multiplication of the output signal by the new weight signal. The input stage can be configured to adapt the output signal of the artificial neuron circuit according to a predefined adaptation signal indicative of a learning rate of the artificial neuron circuit. In possible embodiments the input stage comprises a resistor ladder circuit configured to generate the adapted output signal by adjusting at least one resistive element thereof in accordance with the predefined adaptation signal.

Optionally, but in some embodiments preferably, at least one of the first and second multiplier circuits comprises squaring and a subtraction circuits configured for the generation of said first product signal. The squaring circuit comprises in possible embodiments a diode bridge.

In some possible embodiments at least one of the first and second multiplier circuits comprises a scaling circuit. The scaling circuit is configured in some embodiments to factor out of the product signal thereby generated a scaling constant.

The output signal can be a temporally integrated signal generated by the artificial (e.g. spiking, or non-spiking) neuron circuit. Optionally, the artificial neuron circuit is configured to control at least one of a rise time, width, fall time, and refractory period, of output spike/signal thereby generated. Optionally, the artificial neuron circuit comprises a scaling input stage configured to receive one or more input signals and respective one or more scaling signals, adapt each of the input signals in accordance with its respective scaling signal, and generate an input current of the artificial neuron circuit based on the scaled input signals. Optionally, at least one of the one or more scaling signals is associated with a weight signal generated by the weight update circuit. The artificial neuron circuit can comprise a leaky integrate and fire (LIF) neuron circuit configured to generate the spike signals based on the input current from the scaling input stage. The LIF neuron circuit can comprise a soma module configured to regulate a leakage current used for charging a soma capacitive element thereof.

The artificial neuron circuit can comprise a spike generator configured to generate first and second driving currents whenever a voltage over the soma capacitive element of the soma module is greater than a defined voltage level. The first driving current can be used for charging the soma capacitive element of the soma module. The second driving current can be used for generating the spike signals. A spike shaping module can be used to regulate a discharge current of the soma capacitive element. Optionally, but in some embodiments preferably, the spike shaping module is configured to charge a spike shaping capacitive element thereof with the second driving current from the spike generator, and regulate a discharge current of the soma capacitive element according to voltage level of the spike shaping capacitive element.

The spike generator comprises in some embodiments first and second invertors. The second invertor can be configured to generate the second driving current, and to discharge the spike shaping capacitive element of the spike shaping module whenever the voltage over the soma capacitive element of the soma module is smaller than the defined voltage level. The circuit comprises in possible embodiments an integration module configured to regulate a charging current of an integration capacitive element thereof according to a voltage level over the spike shaping capacitive element. The integration module can be configured to output the temporally integrated signal based on a voltage level of its spike shaping capacitive element.

Another inventive aspect disclosed herein relates to an analog learning system comprising two or more analog signal processing/adaptation circuits according to any of the embodiments disclosed hereinabove or hereinbelow, respective two or more artificial (e.g., spiking) neuron circuits according to any of the embodiments disclosed hereinabove or hereinbelow, each of the artificial neurons is configured to generate an output signal driving a respective one of the two or more analog signal processing/adaptation circuits, a summation circuit configured to generate a summation signal indicative of a summation of the second product signals from the two or more analog signal processing/adaptation circuits, and a factor generator circuit configured to subtract from the summation signal from the summation circuit a reference signal and to thereby generate the feedback signal of said two or more artificial neuron circuits/network or its learning core(s).

Yet another inventive aspect disclosed herein relates to a learning core usable for an artificial neuron network. The learning core comprising: (i) an artificial neuron circuit comprising: a scaling input circuit configured to receive one or more input signals, adapt at least one of the one or more input signals in accordance with a weight signal, and generate an input current of the artificial neuron circuit based at least on the adapted input signal; a leaky integrate and fire (LIF) neuron circuit configured to generate spike signals based on the input current from the scaling input circuit; and an integration circuit configured to generate a temporally integrated signal indicative of temporal integration of at least some of the spike signals; and (ii) an analog signal processing/adaptation circuit comprising an input configured to adapt the a temporally integrated signal in accordance with a predefined adaptation signal e.g., indicative of a learning rate of the artificial neuron circuit, a first multiplier circuit configured to generate a first product signal based on a multiplication of the adapted temporally integrated signal by a feedback signal of said artificial neuron circuit/network or its learning core(s), a weight update circuit configured to generate a new weight signal based on a multiplication of a previous weight signal by a summation of the previous weight signal with the first product signal, and a second multiplier circuit configured to generate a second product based on a multiplication of the temporally integrated signal by the new weight signal.

The LIF neuron circuit of the artificial neuron circuit comprises in some embodiments a soma module configured to regulate a leakage current from the scaling input circuit for adjusting a charging current of a soma capacitive element thereof. The LIF neuron circuit comprises in possible embodiments a spike generator configured to generate first and second driving currents whenever a voltage over the soma capacitive element of the soma module is greater than a defined voltage level. The first driving current can be used for charging the soma capacitive element of the soma module. The second driving current can be used for generating the spike signals.

The learning core can comprise a spike shaping module configured to charge a spike shaping capacitive element thereof with the second driving current from the spike generator and regulate according to voltage level of the spike shaping capacitive element a discharge current of the soma capacitive element.

Optionally, the spike generator of the LIF neuron comprises first and second invertors. The second invertor can be configured to generate the second driving current, and to discharge the spike shaping capacitive element of the spike shaping module whenever the voltage over the soma capacitive element of the soma module is smaller than the defined voltage level value. The learning core comprises in some embodiments an integration module configured to regulate a charging current of an integration capacitive element thereof according to a voltage level over the spike shaping capacitive element of the spike shaping module. The temporally integrated signal is optionally indicative of the voltage of the spike shaping capacitive element.

Another inventive aspect disclosed herein relates to an artificial neural network comprising two or more of the learning cores according to any of the embodiments disclosed hereinabove or hereinbelow, a summation circuit configured to generated a summation signal based on a summation of the second product signal from the analog signal processing circuits of the two or more of the learning cores, and a subtraction circuit configured generate the feedback signal for the learning core based on a subtraction of a reference signal from the summation signal.

Another inventive aspect disclosed herein relates to a method of generating a signal component for a feedback signal of an artificial neuron/network or its learning core(s). The method comprising generating a first product signal based on an output signal of the artificial neuron and a previously generated feedback signal of the artificial neuron/network or its learning core(s), generating a new weight signal from a previously generated weight signal and a summation of the previously generated weight signal with the first product signal, and generating the signal component from a second product signal generated based on the output signal and the new weight signal. The method comprising in some embodiments scaling the output signal according to a predefined learning rate of the artificial neuron. The method can comprise generating the output signal by adapting one or more input signals in accordance with at least one scaling signal and generating an input current of the artificial neuron based on the adapted one or more input signals.

Optionally, but in some embodiments preferably, the method comprises at least one of the following: generating spike signals by the artificial neuron based on the input current; regulating a leakage current for adjusting the input current and charging a soma capacitive element; generating first and second driving currents whenever a voltage over the soma capacitive element is greater than a defined voltage level, and charging the soma capacitive element by the first driving current, and generating the spike signals by the second driving current; charging a spike shaping capacitive element by the second driving current and regulating according to a voltage level of the spike shaping capacitive element a discharge current of the soma capacitive element; discharging the spike shaping capacitive element whenever the voltage over the soma capacitive element is smaller than the defined voltage level value; and regulating a charging current of an integration capacitive element according to a voltage level over the spike shaping capacitive element and outputting the temporally integrated signal based on a voltage level of the integration capacitive element.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIGS. 1A to 1E schematically illustrate analog neuron implementations according to possible embodiments, wherein FIG. 1A shows an electrical circuit implementation of a spiking neuron, FIG. 1B shows a control circuit configured to generate a distribution of intercepts and maximal firing rate for tuning eight spiking neurons, FIG. 1C graphically presents uniform (top), bounded (middle), and pure (bottom), neuron tuning modalities, FIG. 1D graphically presents eight neurons, defined with the tuning distributions of FIG. 1C and driven by linear (top), exponential (middle) and sinusoidal (bottom) input signals, and FIG. 1E is a block diagram for possible adaptive learning-based control of a robotic arm;

FIG. 2A to FIG. 2C schematically illustrate analog implementation of a neural network learning system according to possible embodiments, wherein FIG. 2A is a block diagram of the neural network having a plurality of learning cores, FIG. 2B is a block diagram of a learning block used in each leaning core e.g., to provide PES-driven online learning, and FIG. 2C shows an electrical circuit implementation of a learning block;

FIGS. 3A to 3G schematically illustrate an analog learning system according to possible embodiments, wherein FIG. 3A in a block diagram of a neural network learning system used for the neuromorphic representation, FIG. 3B shows representation of exponential (top) and sinusoidal (bottom) input signals obtained using two neurons with bounded distribution (as shown in FIG. 1C, middle activation) of activation, FIG. 3C shows representation of exponential (top) and sinusoidal (bottom) input signals obtained using four neurons with the with bounded distribution, FIG. 3D shows representation of exponential (top) and sinusoidal (bottom) input signals obtained using eight neurons with the with bounded distribution, FIG. 3E shows representation of a sinusoidal input with eight uniform (FIG. 1C, top) and pure (FIG. 1C, bottom) activated neurons, FIG. 3F shows representational of RMS with bounded, uniform, and pure activations with one to eight neurons, and FIG. 3G graphically presents continual weight tuning of each of the eight neurons during the representation;

FIGS. 4A to 4E schematically illustrate a learning two-dimensional (2D) ANN according to possible embodiments, wherein FIG. 4A schematically illustrates an electronic circuit of a 2D spiking neuron according to possible embodiments, FIG. 4B is a block diagram schematically illustrating a neural network learning system of some embodiment used for 2D representation of exponential and sinusoidal signals; FIG. 4C graphically presents 2D tuning curve realized with equal weights, FIG. 4D graphically presents decoding of the sinusoidal (left) and linear (right) input signals, and FIG. 4E graphically presents error traces for each decoded dimension;

FIGS. 5A to 5D graphically presents neuromorphic transformation of possible embodiments, wherein FIG. 5A shows input (sinus wave) and target transformation (squared input) signals; FIG. 5B shows transformation obtained with one (positively encoded, right) and eight (left) neurons with bounded distribution of activations; FIG. 5C shows transformation result obtained with eight neurons with uniform activation; FIG. 5D shows transformation error obtained with bounded, uniform and pure activations, with one to eight neurons, and FIG. 5E shows continual weight tuning of each of the eight neurons during transformation;

FIGS. 6A to 6C provide neuromorphic dynamical presentation, wherein FIG. 6A is a block diagram of an analog neural network learning system of possible embodiments for 2D oscillatory dynamics, FIG. 6B graphically presents hardware defined oscillation characterized with a leaky oscillation (oscillation is induced by a single 5 mSec pulse (green)), and FIG. 6C graphically presents leaky oscillator sequentially induced by two 5 mSec pulses (green, blue), achieving maintained oscillation;

FIGS. 7A and 7B graphically presents worst case analysis and variation-based tuning representation, wherein FIG. 7A shows bounded (top) and variation-based (bottom) tuning curves for eight neurons with 0, 3, 5, and 7% variation rate (left to right) in transistor fabrication size, and FIG. 7B shows representation of a sinusoidal wave with 100 Monte-Carlo driven runs with bounded distribution of neurons' activation (top) and with variation-based (7%) neurons (bottom);

FIGS. 8A to 8E schematically illustrate a circuit emulator according to some possible embodiments, wherein FIG. 8A is a block diagram of a possible emulator schematic, FIG. 8B shows a representation (left) with eight (8) uniformly distributed tuning curves for eight (8) OZ neurons in both SPICE (lines) and OZ emulator (dashed lines) and a raster plot (right) showing the spikes generated by the eight (8) neurons of the emulator in response to a linearly increasing input voltage (−1 to 1V, shown on the right), FIG. 8C shows a representation (left) of a sinusoidal input wave with eight (8) neurons in both SPICE simulation and OZ emulator and weight modulations (right), FIG. 8D shows a transformation of a sinusoidal input wave to its squared value with eight (8) neurons in both SPICE simulation and OZ emulator, and FIG. 8E shoes a representation of both linear and sinusoidal voltage inputs with high-dimensional representation in both SPICE simulation and OZ emulator; and

FIGS. 9A to 9D schematically illustrate an adaptive neurorobotics application according to possible embodiments, wherein FIG. 9A a block diagram of a simplified schematic of the REACH model for adaptive robotic control, FIG. 9B demonstrates the simulated arm and a designated target point in space, FIG. 9C shoes reaching eight target points while an external force is applied without adaptation, and FIG. 9D shows reaching eight target points while an external force is applied with adaptation using Nengo-based simulation (left) and OZ emulator (right).

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Emphasis instead being placed upon clearly illustrating the principles of the invention such that persons skilled in the art will be able to make and use the circuit designs, once they understand the principles of the subject matter disclosed herein. This invention may be provided in other specific forms and embodiments without departing from the essential characteristics described herein.

The present application provides a detailed, fully analog design usable for NEF-based online learning schemes. Heretofore, NEF was adopted for both digital [17] and hybrid (analog/digital) [10] [18] neuromorphic circuitry, the present disclosure provides a detailed, fully analog design for NEF-based online learning. Circuit design of the disclosed embodiments utilizes a spiking neuron (e.g., OZ neuron [14]), configured as an analog implementation of NEF-inspired spiking neuron. Optionally, but in some embodiments preferably, the neuron utilized is a programmable spiking neuron, which can support arbitrary response dynamic. Online learning was used to represent high-dimensional mathematical constructs (encoding and decoding with spiking neurons), transform of one neuromorphic representation to another, and implement of complex dynamical behaviors. The disclosed neuron circuit designs support the basic three fundamental principles of NEF (representation, transformation, and dynamics) and can therefore be of potential use for various neuromorphic systems.

For an overview of several example features, process stages, and principles of the invention, the examples of spiking neurons illustrated schematically and diagrammatically in the figures are intended for learning circuit applications. These circuitries are shown as one example implementation that demonstrates a number of features, processes, and principles used to provide analog online leaning implementations, but they are also useful for other applications (e.g., utilizing other types of spiking, or non-spiking, neuron implementations) and can be made in different variations. Therefore, this description will proceed with reference to the shown examples, but with the understanding that the invention recited in the claims below can also be implemented in myriad other ways, once the principles are understood from the descriptions, explanations, and drawings herein. All such variations, as well as any other modifications apparent to one of ordinary skill in the art and useful in learning system applications may be suitably employed and are intended to fall within the scope of this disclosure.

Circuit simulations of the embodiments disclosed herein were executed using LTspice, by Analog Devices [20], which is based on the open-sourced SPICE framework [21], and utilizes the numerical Newton-Raphson method to analyze non-linear systems [22]. Signal analysis was performed using Python scripts developed by the inventors. A scalable Python-based emulator was designed to efficiently demonstrate larger scale designs of the circuits disclosed herein on, supporting the emulation of many OZ neurons and numerous PES-based learning circuit blocks. A comparison of the obtained results to Nengo-based simulations is provided in [30].

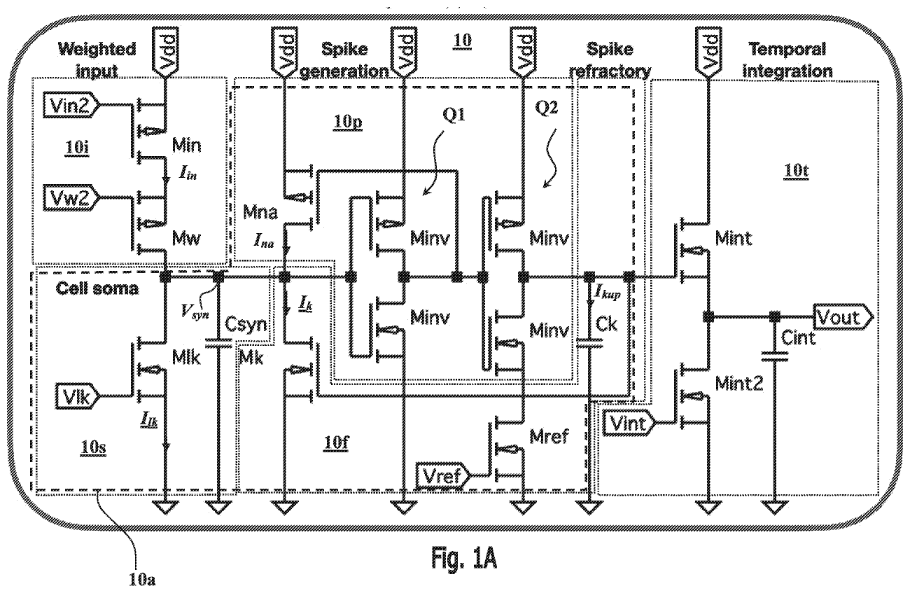

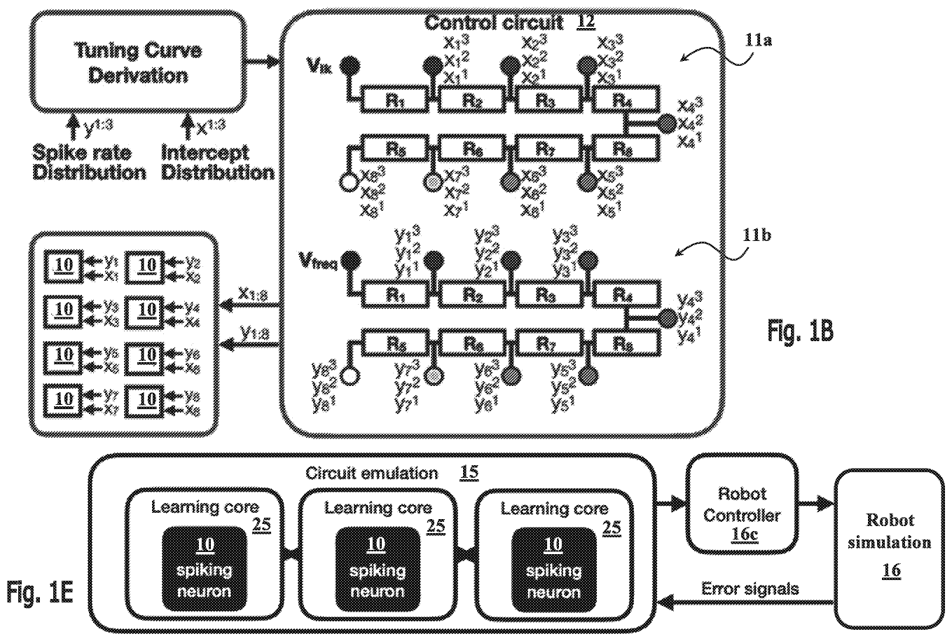

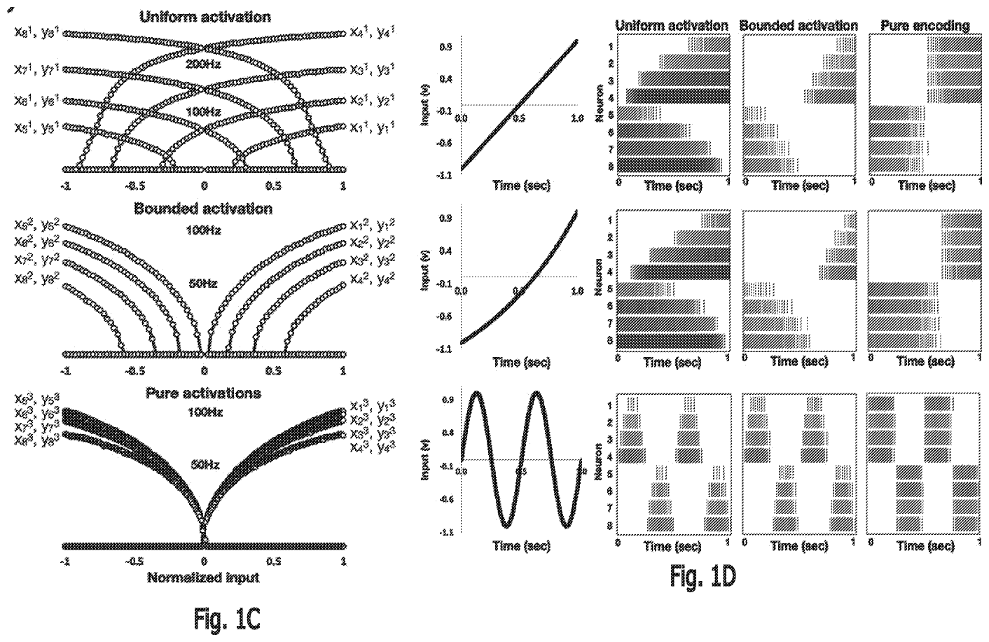

FIG. 1A shows a neuron circuitry 10 (e.g., OZ neuron [14]) according to some possible embodiments, designed as an analog implementation of a NEF-inspired spiking neuron. In this neuron circuit 10 design, the input voltage Vin2 is transformed by the input stage 10i into a proportional current, driven into a voltage-amplifier leaky integrate and fire (LIF) neuron circuit 10a. The LIF neuron 10a produces a spike train according to its response dynamic (tuning curve), which is introduced into an integrator circuit 10t configured to provide temporal integration (Vout) of the produced spikes. The neuron circuit 10 can be explicitly defined to feature arbitrary tuning curves e.g., following NEF's neuron specifications.

In NEF, a tuning curve is described with an intercept, the value for which the neuron starts to produce spikes at a high rate and a maximal firing rate. The response dynamic of the neuron circuit 10 can be defined by the voltage signal values of Vₗₖ and V_{ref}, where Vₗₖ controls the discharge rate of the capacitive element C_{syn} (via the voltage-amplifier LIF neuron 10a), thus controlling the neuron's intercept, and Vᵢₙₜ controls the spikes' refractory period, thereby controlling the neuron's firing rate. The neuron circuit 10 is designed to exhibit high predictability of the produced spike trains, and a complete correspondence with NEF across firing rates, intercepts, and encoders.

More particularly, the neuron circuitry 10 is configured to provide precise control over the dynamics of the generated spikes, including the spikes' rise time, width, fall time, and refractory period. The capacitive element C_{syn} provided in the cell soma module 10s is used to model the neuron membrane, and the voltage signal Vₗₖ, which regulates the conductance of transistor Mlk, is used to control the leakage current Iₗₖ through the transistor Mlk. In the absence of an input current Iᵢₙ from the input stage 10i due to incoming spikes (flat phase), Iₗₖ drives the membrane voltage V_{syn} down to a zero voltage (0 V). When an input current Iᵢₙ is produced by the input stage 10i, the net incoming current, Iᵢₙ−Iₗₖ, is charging the capacitive element C_{syn}, thereby increasing the membrane voltage V_{syn} thereover.

The spike generator module 10p comprises first and second inverter circuitries, Q1 and Q2, controlled by the membrane voltage V_{syn}. As the membrane voltage V_{syn} is increased, it causes the output of the first inverter Q1 to change into a LOW logical state that activates the transistor Mna, through which I_{Na} current is driven for charging the membrane capacitive element C_{syn}, thereby producing a sustained high voltage (constituting the spike). The low logical state at the output of the first inverter Q1 activates the top Minv transistor of the second voltage inverter Q2, which output is thus changed into a HIGH logical state and drives the Iₖᵤₚ current for charging the capacitive element Ck of the spike refractory module (also referred to herein as spike shaping module) 10f, which is configured to control the width of the generated spikes. As Ck is charging, it activates the transistor Mk, through which current Iₖ is driven, thereby discharging the membrane capacitive element Csyn.

As the voltage V_{syn} over the membrane capacitive element C_{syn} is decreased, the state of the first voltage inverter Q1 is changed to output a HIGH logical state, thereby deactivating transistor Mna and terminating the charging current Iₙₐ of the membrane capacitive element C_{syn}. Responsively, the state of the second inverter Q2 is changed to output a LOW logical state, thereby terminating the charging current Iₖᵤₚ of the capacitive element Ck of the spike refractory module 10f, and allowing discharge of Ck through the Mref transistor. The discharge speed of the capacitive element Ck through the transistor Mref can be controlled by the Vref voltage signal. As long as the current through the transistor Mref is not strong enough to discharge Ck, the neuron circuit 10 cannot be further stimulated by incoming current (assuming Iᵢₙ<Iₖ), thereby constituting a refractory period. This process is a direct embodiment of the biological behaviour, in which an influx of sodium ions (Na⁺) and a delayed outflux of potassium ions (K⁺) govern the initiation of an action potential.

In possible embodiments the cell soma module 10s of the neuron circuit 10 is connected to the spike generator module 10p via an operation amplifier (op-amp) which output is switched between positive and negative voltage levels according to a defined threshold voltage (Vₜₕ), as shown in [14]. The op-amp provides the neuron 10 with a digital attribute, splitting the neuron into an analog pre-op-amp circuit and a digital post-op-amp circuit. Particularly, when an incoming current is increasing V_{syn} to exceed the threshold voltage (Vₜₕ), the op-amp yields a square signal, which generates a sharp Iₙₐ charging current response. This fast response induces sharp swing-ups in the V_{syn} and Vout voltages. Without the op-amp, this transition between states is gradual. Although both designs permit spike generation, the op-amp based design can generate spikes in a higher frequency and amplitude.

### Control Circuit

The neuron circuitries (10) disclosed herein are configured to use two control signals Vₗₖ and V_{ref} (FIG. 1A), for setting the neuron's intercept and maximal firing rate. However, individually controlling each neuron (10) is tedious and not feasible in a large-scale design. Therefore, the neurons are programmed in some embodiments to exhibit different distributions of response dynamics. One way in which such a distribution can be configured is utilizing simple resistor ladders (a serially connected set of resistors), as exemplified in FIG. 1B, wherein one ladder 11a is configures to set the neurons intercepts, and the other ladder 11b is configured to set the maximal firing rate of the neuron. The control circuit 12 in FIG. 1B is configured to provide distribution of intercepts (x₁-x₈) and maximal firing rate (y₁-y₈) for tuning of eight neurons. In this simple control design, changing the voltages that feed the resistor ladders 11a, 11b uniformly shifts the response of the controlled neuron (10) ensemble in the representation space.

For demonstration, the control circuit 12 was simulated to generate various distributions of tuning curves, including a uniform and bounded intercept distribution (by feeding different input values to both resistor ladders) and a pure configuration in which the intercepts were set to zero, as shown in FIG. 1C. Three tuning modalities are depicted in FIG. 1C, as follows: uniform (top), bounded (middle) and pure (bottom). The illustrated sample points were measured on the circuit using the control circuit 12 shown in FIG. 1B.

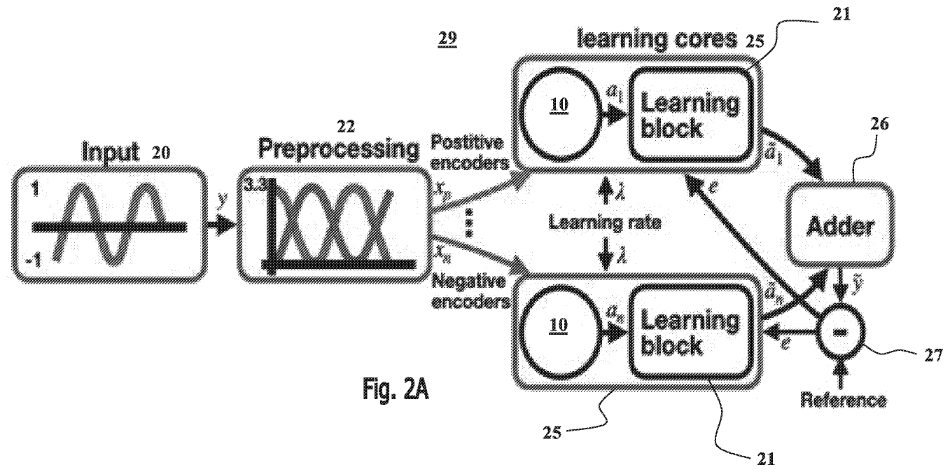

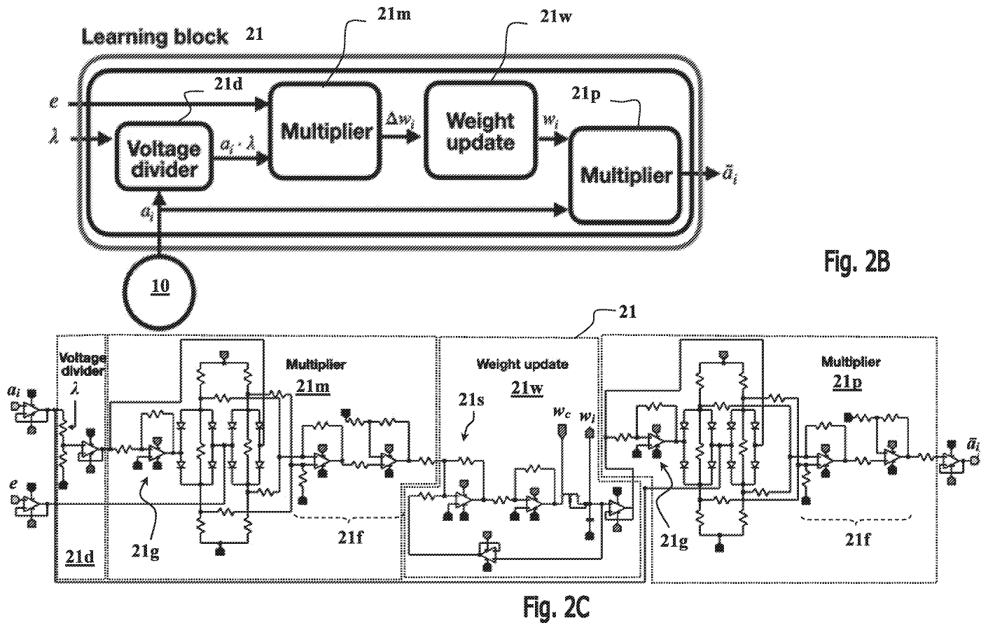

Each ensemble was driven by linear, exponential, and sinusoidal inputs to highlight their different response dynamic. FIG. 1D accordingly depicts raster plots of eight neurons 10, defined with the tuning distribution shown in FIG. 1C, and driven by a linear (top), exponential (middle) and sinusoidal (bottom) input signals. In some embodiments a preprocessing module (22 in FIG. 2A) is used to generate a signal for positively encoded and negatively encoded neurons 10. Therefore, by assuming symmetry of activations (like the one demonstrated in FIG. 1C), only four activations should be set for the configuration of eight neurons.

### Learning Core

FIGS. 2A to 2C schematically illustrate a novel analog circuitry 29 with which neurons, such as, but not limited to, the spiking neuron 10 shown in FIG. 1A could be utilized to learn neuromorphic representations, transformation, and dynamics using the realization of the PES learning rule. It is noted that this circuit design is not limited for use with the spiking neuron circuit 10 shown in FIG. 1A. The neuron circuit 10 can be used for online learning with neuromorphic analog circuit, and it is scalable to comprise numerous instances of the learning cores 25 shown in FIG. 2A. In each learning core 25, a normalized input (20) signal y is preprocessed by the preprocessing module 22 to drive positively and negatively encoded neurons 10. In possible embodiments the preprocessing module 22 is slightly differently configured for each encoding modality, and it was simplified in this non-limiting example for clarity (e.g., see for more details).

The output signal aᵢ of each neuron 10 is rate coded (in accordance with the neuron's tuning curve) and temporally integrated by the output stage (10t) of the neuron. The integrated neuron output signal aᵢ is driven into a learning block (also referred to herein as analog signal adaptation or processing circuit) 21 alongside some normalized error signal (also referred to herein as factoring term or feedback signal) e and a learning rate λ. The learning block 21 (shown in FIGS. 2B and 2C) processes the signal aᵢ from the neuron 10 and transforms it to an optimized value by minimizing the error signal using PES learning. The learning block 21 is also responsible for the maintenance of the neuron's weight wᵢ. With reference to FIG. 2A, the outputs āᵢ of all the learning blocks 21 are summed by an adder block 26, to thereby produce an estimated signal y̅. The estimated signal y̅ is subtracted by subtraction unit 27 from the desired signal i.e., y, thereby providing an error signal e. The error signal e is divided by the number (n) of neurons (via a voltage divider; not shown in FIG. 2A) and sent back to the learning block 21.

An electrical circuit of the learning block 21 according to some possible embodiments is shown in FIG. 2C. The learning block circuit 21 comprises a voltage divider 21d (accounting for a learning rate λ), two multipliers, 21m and 21p, and a weight update module 21w.

The voltage divider 21d is configured to utilize a resistor ladder to scale the signal aᵢ received from the neuron 10 in accordance with the learning rate A.

The analog multipliers, 21m and 21p, were implemented by subtracting circuit 21f (including a negating summation circuit serially connected to an inverting circuit) configured to subtract the outputs of two analog squaring circuits, each implemented by a pair of serially connected diode bridge. One squaring circuit is driven by the summation of the two signals (u,v) derived from the error and neuron output signals, e and aᵢ, and the other by signals derived from their difference, to thereby obtain a scaled multiplication of these signals, as follows: (u+v)²−(u−v)²=4uv. The differential amplifier circuit 21f further modulates the resulting multiplication value to factor out the scaling constant. The diode bridge is configured to operate in an extensive frequency range, and its square law region is at the core of the squaring circuit. The left diode bridge of each multiplier 21m, 21p handles the (u+v)² operation, and the right diode bridge of each multiplier 21m,21p handles the (u−v)² operation, where v is negated by an inverting op-amp circuit 21g. The squaring circuit's output current can be approximated with Taylor's series. As the differential output across the diode bridges is symmetric, each bridge's output comprises the even terms of the combined Taylor expansions. Odd terms are removed due to the four diode currents, as they produce frequency components outside the multiplier's passband. Therefore, the resulted output of the circuit is proportional to the square of its input.

The first multiplier 21m multiplies the normalized error e with the neuron's temporally integrated spikes aᵢ, constituting a weight update. Weights we are implemented in the learning block 21 utilizing a memory cell (transistor-capacitor), allowing the maintenance of negative values at low overhead. The weight update circuit 21w sums the updated value produced by the first multiplier 21m with its current weight value wᵢ using summing amplifier circuit 21s. The second multiplier 21p multiplies the modified weight signal wᵢ with the neuron's temporally integrated spikes signal aᵢ, thereby providing the modified neuron's output signal āᵢ.

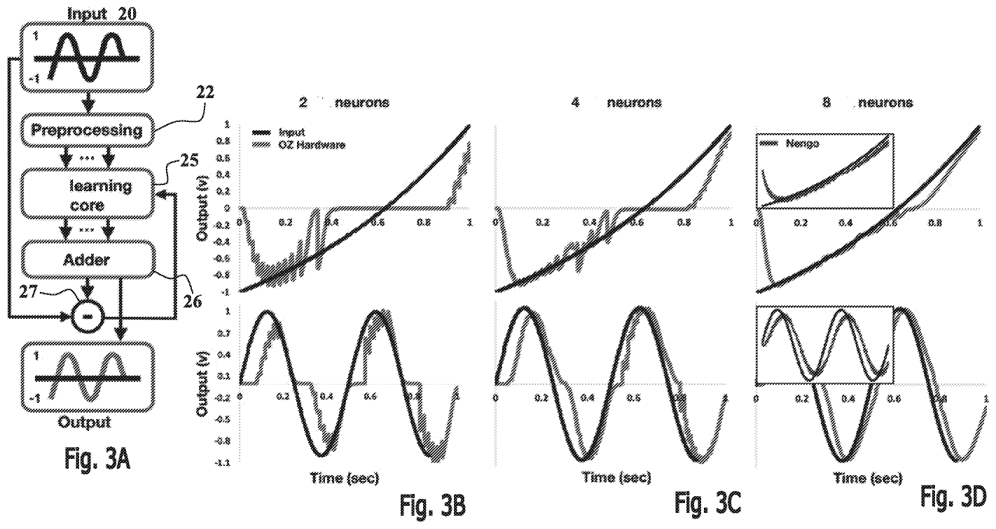

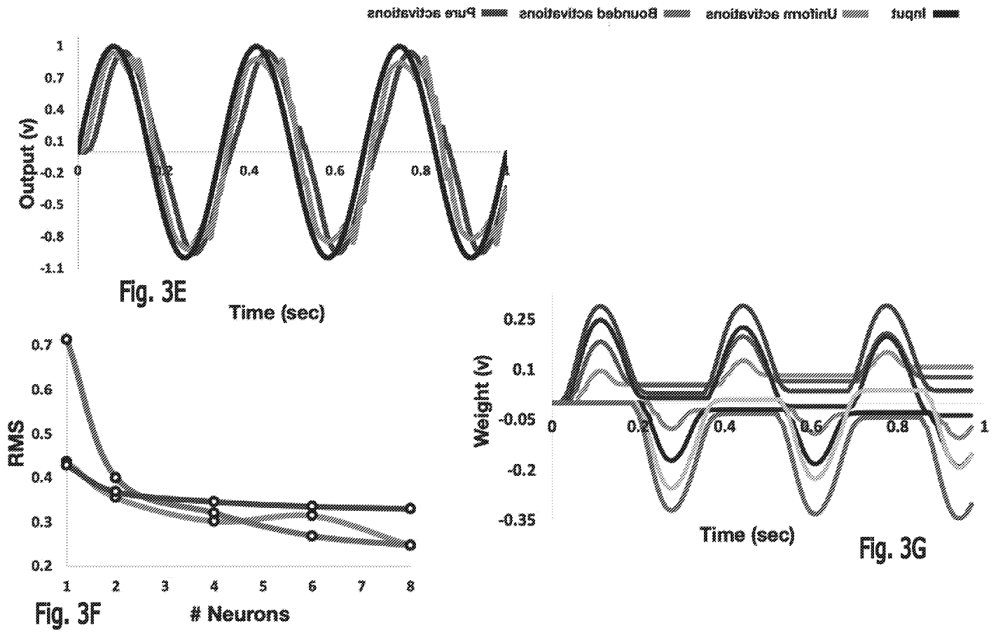

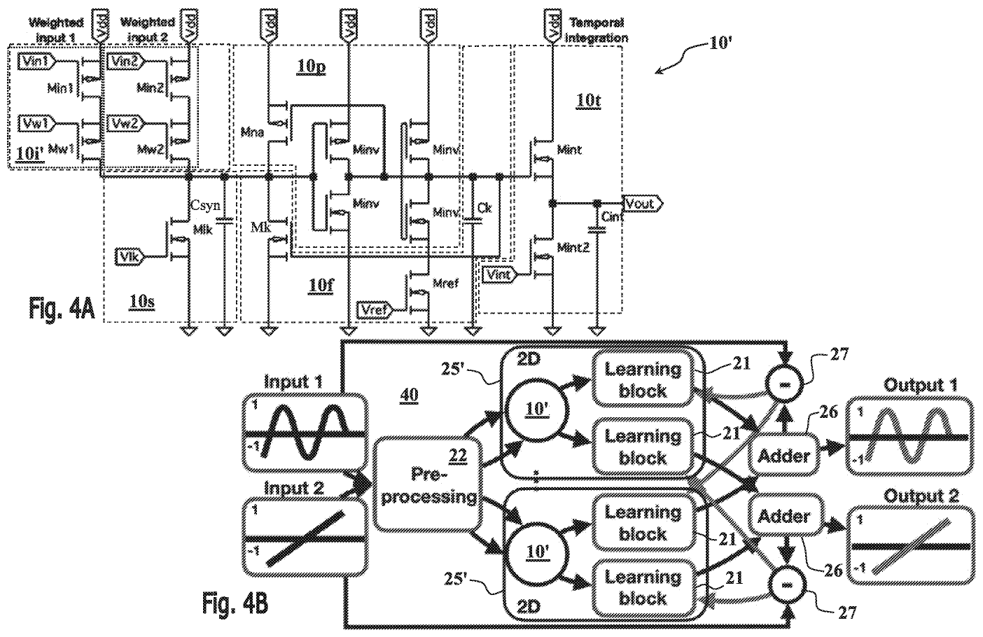

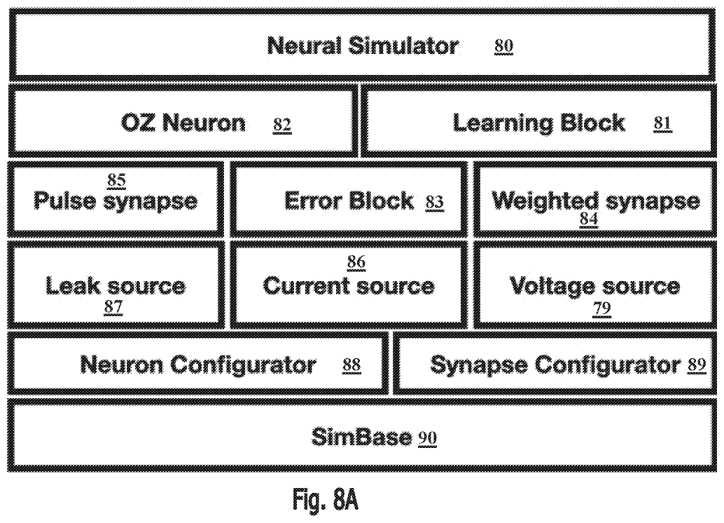

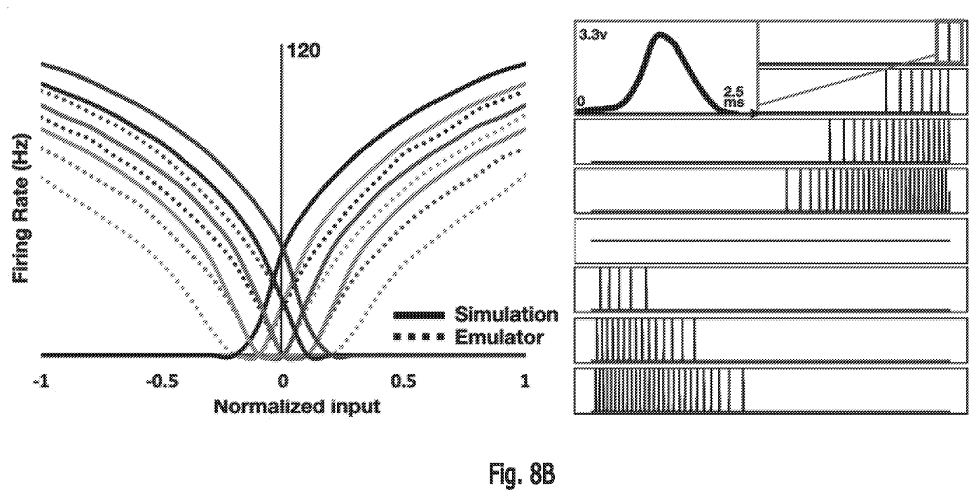

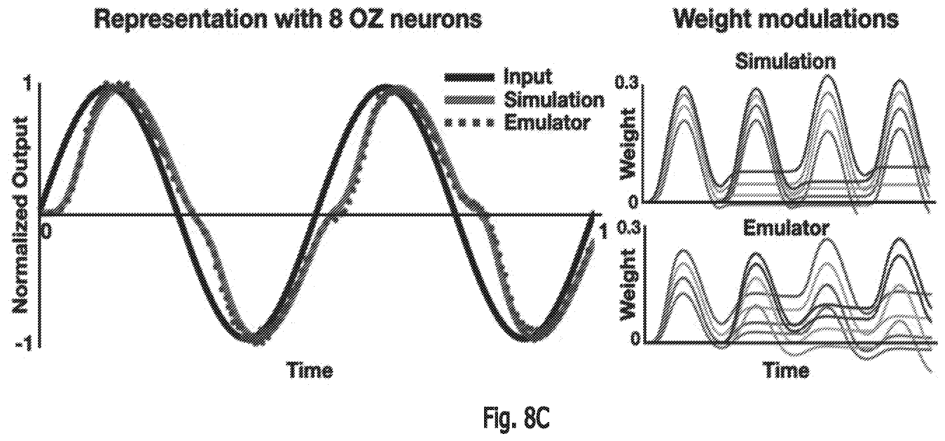

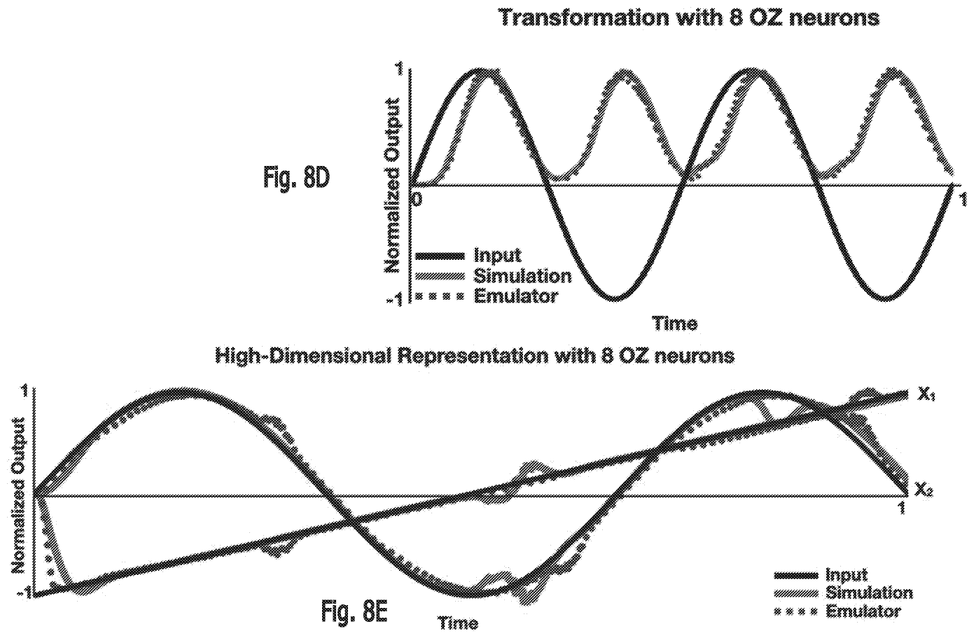

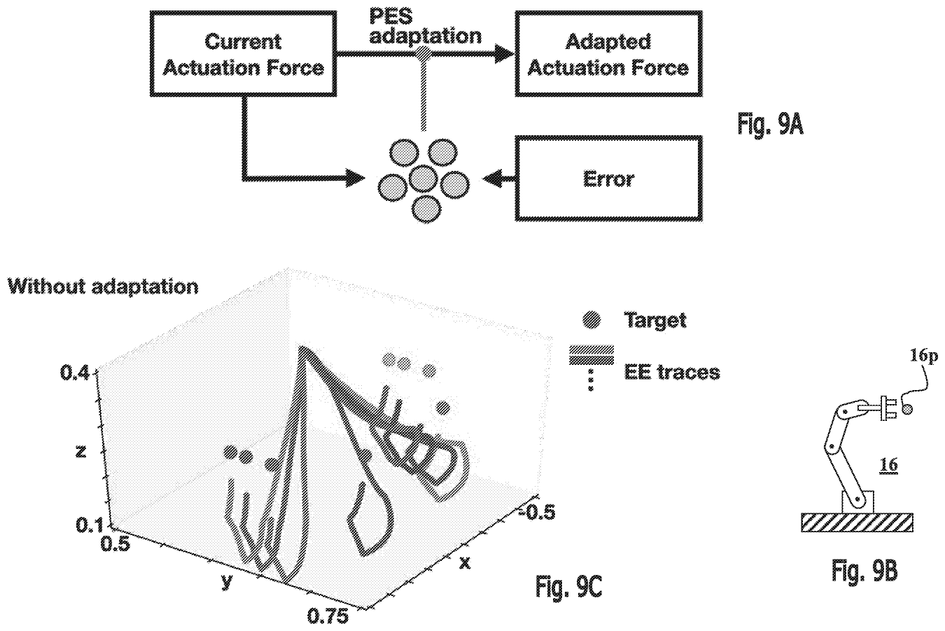

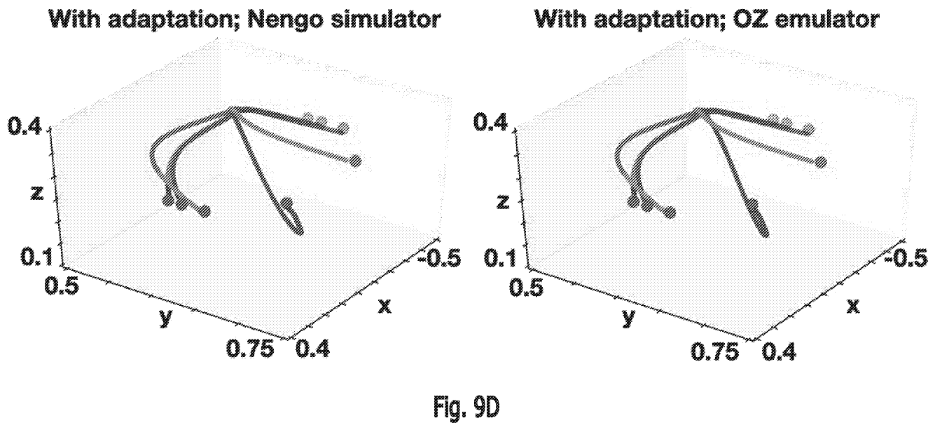

The present application provides a hardware PES-driven analog design that can be used to implement NEF's three fundamental principles: representation, transformation, and dynamics (described above). The results shown in the figures were generated using SPICE simulations (except for FIGS. 8 and 9, which were generated using a Python-based emulator (described below), and FIG. 3D, wherein the small boxed traces were generated using Nengo.

### Representation

In NEF-driven representation, input signals are distributively encoded with neurons as spikes (following each neuron's tuning) and decoded by either calculating a set of decoders (Equation 2) or learning a set of weights (Equation 5) via PES learning (Equation 6). In both cases, neuromorphic representation entails a reference signal (supervised learning).

The disclosed embodiments realize neuromorphic representation with PES learning, utilizing the learning blocks (21 in FIGS. 2B and 2C), that can use the input signal itself as a reference signal (see, FIG. 3A). The learning analog system was used to encode and decode exponential and sinusoidal signals with two, four, and eight spiking neurons (see FIG. 3B to 3D). As expected, following Equation 4, as the number of neurons is increased, the performance of the learning system is improved. Hardware simulation-derived results (light traces in FIG. 3D) that were obtained closely follow Nengo's NEF-based software simulation (purple boxed traces in FIG. 3D), with a cross-correlation similarity (sliding dot product) of about 0.872±0.032. It is shown herein that analog learning systems hereof comprising only eight (8) neurons can accurately represent the input with a swift convergence toward the represented value.

As described hereinabove, representation is highly dependent on the neurons tuning. The results shown in FIGS. 3B to 3D were derived using neurons with a bounded activation distribution. Sinusoidal inputs were represented with neurons characterized by uniform and pure activations, following FIG. 1C. Results are shown in FIG. 3E. This representation has been evaluated using the three activation schemes with one to eight neurons, by calculating the error's root mean square (RMS). The results demonstrate the superior performance for bounded distribution of neuron tuning (see FIG. 3F). The continually changing weights of each neuron are shown in FIG. 3G, demonstrating continual online learning.

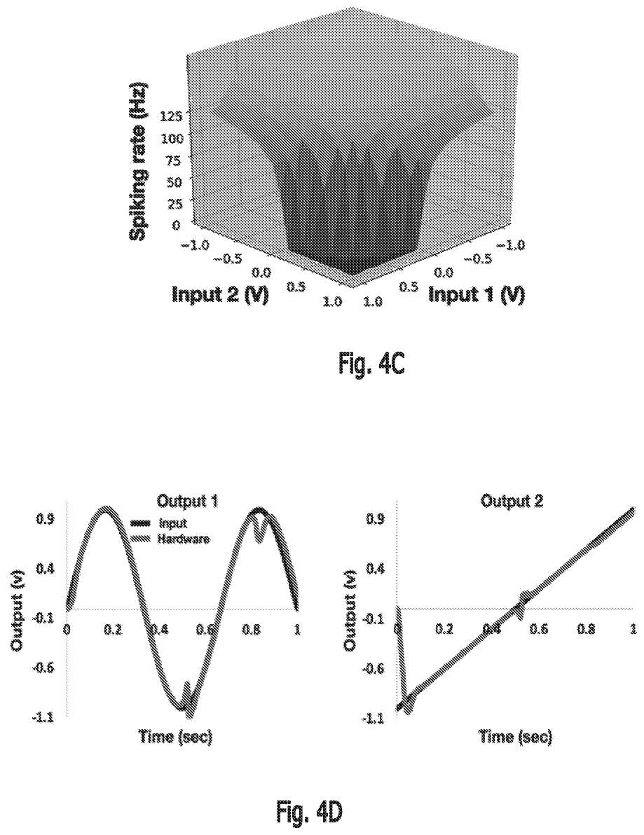

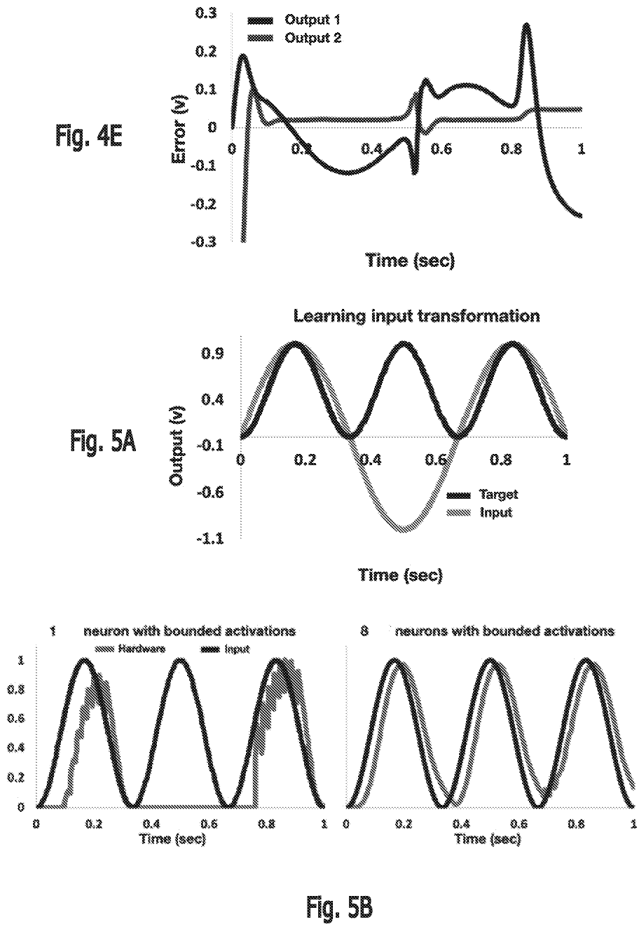

An essential characteristic of NEF is the ability to represent high-dimensional mathematical constructs with high-dimensional neurons. Spiking neurons, such as the OZ neurons (10), can be driven with high-dimensional signals (using few weighted inputs), featuring high-dimensional tuning [14]. An analog learning system 40 utilizing 2D spiking neurons 10′ is shown in FIGS. 4A and 4B. As seen in FIG. 4A, the input stage 10i′ of the 2D spiking neuron 10′ comprises two input branches configured to receive the two input signals Vin1 and Vin2. All other modules of the 2D spiking neuron 10′ are similar to those of spiking neuron 10 shown in FIG. 1A. By setting a similar weight (Vw1˜Vw2) for the two incoming signals, Vin1 and Vin2, the neuron's tuning shown in FIG. 4C can be derived. The circuit shown in FIG. 4B, with eight (8) 2D spiking neurons 10′ was used to represent a 2D input signal, wherein one dimension follows an exponential rising signal, and the other is a sinusoidal wave. Representation results are shown in FIG. 4D and error traces in FIG. 4E.

### Transformation

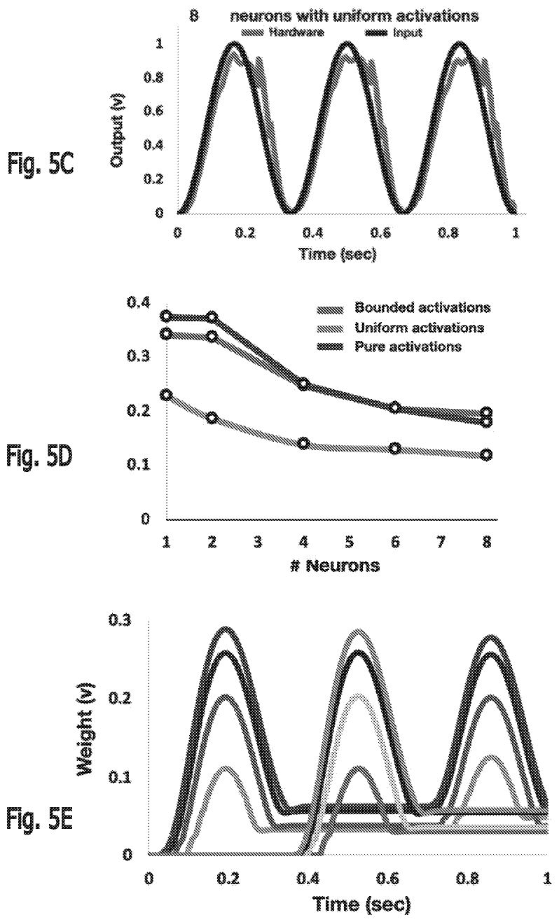

While in signal representation, the input signal itself is represented, in signal transformation some function of the input signal is represented. Here, the system was utilized to neuromorphically perform squaring of an input sinusoidal signal (see FIG. 5A). Transformation results with one positively encoded neuron (1) and eight (8) bounded neurons are shown in FIG. 5B. While one positively encoded neuron cannot account for the input signal's negative phase, it provides a temporal output only at the positive sinus phase. With eight neurons, however, the results show accurate transformation (see FIG. 5C). The transformation error is measured here with bounded, uniform, and pure activations, with one (1) to eight (8) neurons. The results show superior performance for a uniform distribution of neuron tuning (see FIG. 5D). The neuromorphic system presented herein continually modulates neuronal weights. Weight tuning for each of the eight (8) spiking neurons during transformation is shown in FIG. 5E.

### Dynamics

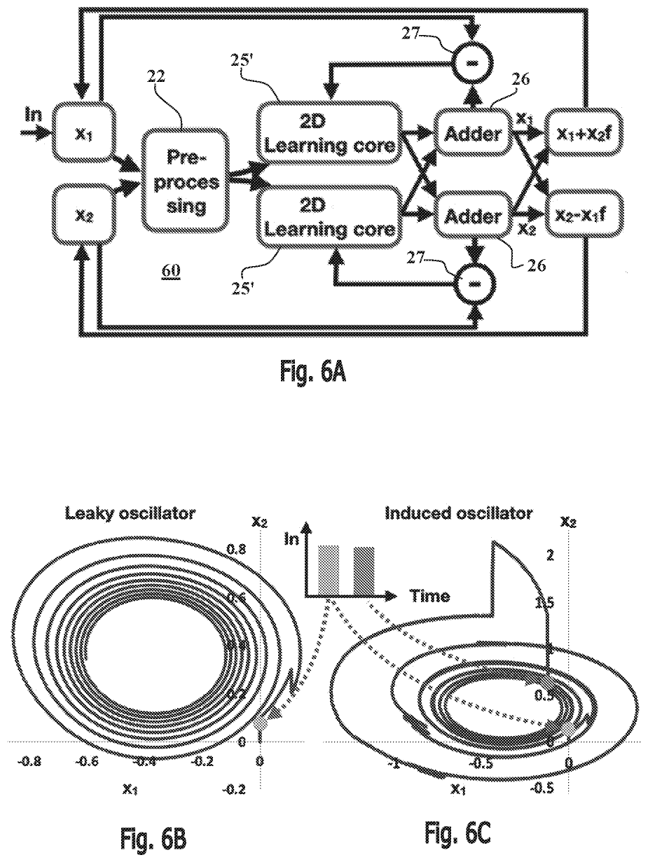

Neuromorphic representation and transformation are the first two main pillars of NEF. The third is the realization of a dynamical system. Embodiments disclosed herein were used to implement the induced leaky oscillator defined in Equation 9. FIG. 6A shows a block diagram 60 of a 2D learning system according to possible embodiments utilizing the 2D representation scheme described above with reference to FIGS. 4A to 4E. The system was traced in two dimensions (x₁ and x₂) throughout time, following induction with a single three mSec pulse (driven to x₁). The resulting oscillatory dynamic is shown in FIG. 6B, wherein oscillations slowly converges back to zero at a rate determined by the hardware's leaky characteristic. When induced again, oscillation can be maintained, as demonstrated in FIG. 6C, where two five mSec pulses were used, spaced by a two second time interval.

### Worst-Case Analysis

Analog circuit elements (e.g., resistors, capacitors, transistors) are prone to process, voltage, and temperature (PVT) variations. “Process” in this case refers to manufacturing as a measure of the statistical variability of the physical characteristics from component to component as they come off the production line (ranging from variations in mask alignment and etching times to doping levels). These variations affect the electrical parameters of the components, such as the sheet and contact resistance. Analog components also change in time due to their endurance limit (the stress level below which an infinite number of loading cycles can be applied to a material without causing fatigue failure). Monte Carlo-driven variations was used to study:
1. The way the hardware design handles a high degree in components variation; and
2. To compare the traditional variation-based spanning of a representation space with the programmed neurons tuning approach.

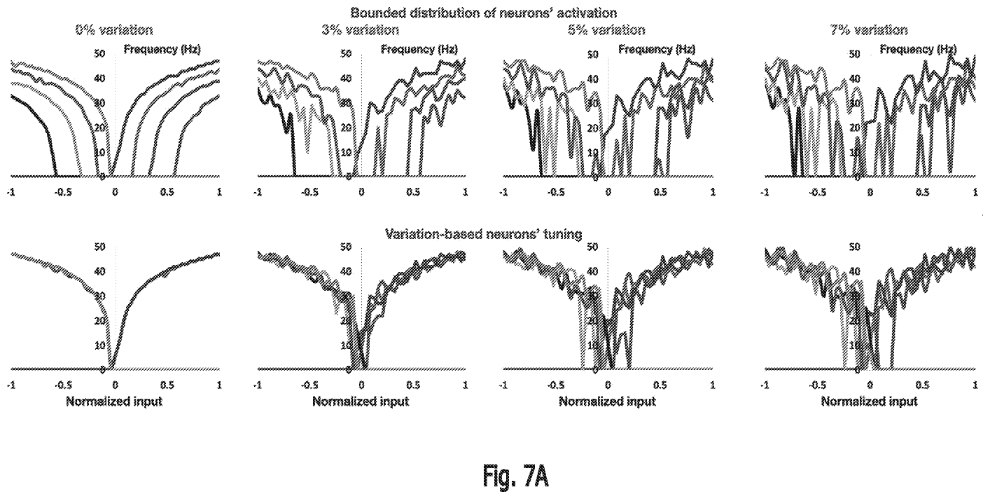

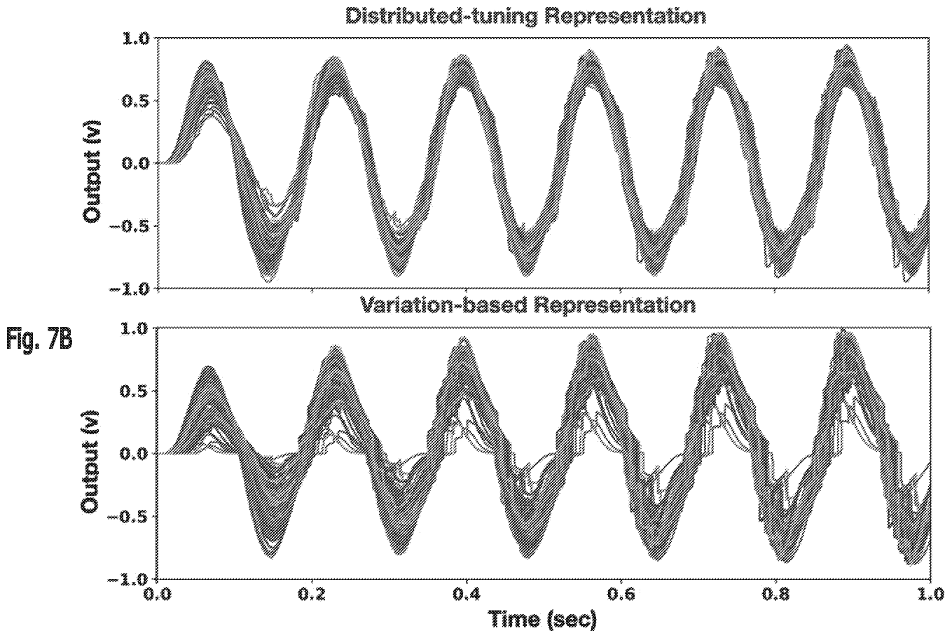

In each simulation run, all components of the circuit design were varied within an explicitly defined variation rate (e.g., in the 5% variation case study, a 10 nF capacitor of possible embodiments of the OZ circuit design will randomly be specified in the 9.5 to 10.5 nF range). Transistors were similarly varied in their sizes. The level of process variation increases as the process size decreases. For example, a fabrication process that decreases from 350 nm to 90 nm, will reduce chip yield from nearly 90% to a mere 50%, and with 45 nm, the yield will be approximately 30% [23]. Hundred (100) Monte Carlo runs were simulated with 3, 5, and 7% variability. The resulting neurons' tuning in the bounded distribution of intercepts and firing rates and with a single setpoint (used for the variation-based spanning of representation space) are shown in FIG. 7A. Results show that the intercepts are much more prone to variation than the neurons firing rate. Importantly, it is shown that relying on process variation for the manifestation of neurons with heterogeneous tuning curves is inadequate compared to a predefined distribution of neuron tuning (see FIG. 7B). These results further demonstrate that the learning circuit design disclosed herein can compensate for process variation.

### Circuit Emulator

To efficiently demonstrate the circuit designs disclosed herein on a large scale, a neural emulator (80) been we designed and implemented. The emulator 80, schematically illustrated in FIG. 8A, is a scalable Python-based framework designed to support compiling, testing, and deploying OZ-based SNNs, supporting PES-based learning as described hereinabove. The emulator 80 comprises OZ neuron emulation block(s) 82 and their respective learning emulation block(s) 81, pulse synapse blocks(s) 85, error block emulation blocks(s) 83, weighted synapse block(s) 84, leak source emulation block(s) 87, synapse configuration block(s) 89, neuron configuration block(s) 88, and/or simulation object (SimBase) block(s) 90.

In contrast to the SPICE-driven simulations described hereabove, this Python-based emulator 80 can realize the SPICE-derived component behaviour without simulating the actual components, allowing an efficient evaluation of the circuit. The emulator 80 is configured in some embodiments as a time-based emulator with a predefined simulation time and number of steps. At each step, the emulator's scheduler (not shown) traverses a list of simulation objects (SimBase) 90, for activating them. The simulation object 90 structure constitutes in some embodiments the network design, which it is up to the user to define. Each simulation object 90 can be aware of the simulation time step via a configuration class, and its responsibility is to process the input data received via a voltage or a current source interface object 86,79.

Following each activation step, each object stores its resulting state. Each building block (learning block 81, error block 83, etc.) has a corresponding model created using its SPICE simulation with varying input signals. Blocks can be built hierarchically. For example, the OZ neuron block 82 comprises in some embodiments the pulse current synapse block 85, which comprises a current source 86. The emulator 80

FIG. 8B demonstrates the generated neuron's tuning curves and the corresponding generated spikes of the emulator 80. A SPICE-made spike was encapsulated in the emulator 80 and iteratively generated in Python following the desired tuning curve, specified by OZ's voltage signals described hereinabove. SPICE and emulator-generated neuron tuning show high correspondence. Similar to FIG. 3D, the emulator 80 was used to represent sinusoidal waves with 8 (eight) neurons, as shown in FIG. 8C. The results show a very high correlation with the SPICE circuit simulation (cross-correlation similarity (sliding dot product) of 0.904±0.01), thus demonstrating the accurate emulation of the learning core. Weight modulations in both the SPICE simulation and the emulator show comparable patterns. Similarly, high-dimensional representation (FIG. 4C) and transformation (FIG. 5B) demonstrate the emulator's accuracy (FIG. 8D to 8E).

### Application in Adaptive Neurorobotics

In the past few decades, multijoint open-chain robotic arms have been utilized in a diverse set of applications, ranging from robotic surgeries to space debris mitigation [28]. The control of robotic arms is currently dominated by proportional, integral, and derivative (PID)-based modelling. Such a model aims to accurately represent the controlled system. It would capture the effect of external perturbations and the system's internal dynamics on its ability to move. Thus, it provides signals for movement control, given a desired location. However, in a human collaborative-assistive setting, the controller should consider kinematic changes in the system, such as object manipulation of an unknown dimension or at an unknown gripping point.

Neuromorphic systems have been shown to outperform PID-based implementation of the required nonlinear adaptation, particularly in their ability to handle high degree-of-freedom systems. One possible implementation for neuromorphic control is the recurrent error-driven adaptive control hierarchy (REACH) model proposed by DeWolf and colleagues [34]. REACH is powered by PES, implemented using NEF, realized within the Nengo development environment, and open-sourced by Applied Brain Research Inc. The model has been demonstrated to control a three-link, nonlinear arm through complex paths, including handwritten words and numbers. It can adapt to environmental changes (e.g., an unknown force field) and changes to the physical properties of the arm (e.g., tear of joints) (FIG. 9A).

To demonstrate the applicability of the circuit designs disclosed herein, the OZ and learning core emulator 80 were used to implement REACH on a six (6) degree-of-freedom robotic arm in a physical simulator 16 (FIG. 9B). The following two simulations were implemented: (i) wherein an external force field in applied on the robot's joints i.e., the arm cannot accurately reach the specified target points 16p without adaptation, as the internal joint's dynamic does not consider unknown perturbations (see FIG. 9C): and (ii) wherein adaptive signals allowing the arm to adjust its behaviour were used in real time using PES. The classical REACH Nengo-driven model was used with the circuit emulator 80 to power the robotic arm adaptation. Both Nengo and OZ show similar adaptation patterns, allowing the arm to reach the desired target points accurately while an external force field is applied (see FIG. 9D).

Analog components are particularly vulnerable to fabrication variability. There are several techniques to reduce the process variation, for example, adding dummy transistors to pad the operational transistors in the layout stage. Fortunately, heterogeneous neuronal tuning is desirable with NEF, as it provides the variability in activation needed for spanning a representation space. Circuit variability was shown to be essential for adequately spanning a representation space [18]. NEF's computational approach, therefore, embraces variability. However, it is shown that relying on process variation alone may require a large number of neurons. It is demonstrated that programming neuron tuning, enables to better span a representation space per a given number of neurons. More importantly, even though a post-silicon calibration sequence can be used to compensate for process variation during neuron programming, it is shown here that the analog learning circuits disclosed herein can inherently compensate for such variations. Accordingly, the analog learning circuit design of the present application can therefore learn to adapt to changes within itself.

It should be understood that throughout this disclosure, where a process or method is shown or described, the steps of the method may be performed in any order or simultaneously, unless it is clear from the context that one step depends on another being performed first. It is also noted that terms such as first, second, . . . etc. may be used to refer to specific elements disclosed herein without limiting, but rather to distinguish between the disclosed elements.

As described hereinabove and shown in the associated figures, the present invention provides analog learning circuitries and neurons useful for neural network applications. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above. all without exceeding the scope of the claims.

1. An analog learning system comprising:
two or more analog signal processing circuits each configured for generating a component signal for a feedback signal of a respective artificial neuron circuit, and comprising: an input stage configured to receive and adapt an output signal of said artificial neuron circuit; a first multiplier circuit configured to generate a first product signal indicative of multiplication of the adapted output signal by a previously generated feedback signal of said artificial neuron circuit; a weight update circuit configured to generate a new weight signal based on a multiplication of a previously generated weight signal of said analog signal processing circuit by a summation of said previously generated weight signal with said first product signal; and a second multiplier circuit configured to generate said signal component as a second product signal based on a multiplication of said output signal by said new weight signal;
said respective two or more artificial neurons circuits, each of said two or more artificial neuron circuits is configured to generate an output signal driving a respective one of said two or more analog signal processing circuits;
a summation circuit configured to generate a summation signal indicative of a summation of the second product signals from said two or more analog signal processing circuits; and
a factor generator circuit configured to subtract from the summation signal from the summation circuit a reference signal and to thereby generate the feedback signal of said two or more artificial neuron circuits.

2. The analog learning system according to claim 1 wherein the input stage comprising a resistor ladder circuit configured to adapt the output signal of the artificial neuron circuit according to a predefined adaptation signal indicative of a learning rate of said artificial neuron circuit by adjusting at least one resistive element thereof in accordance with the predefined adaptation signal.

3. (canceled)

4. The analog learning system according to claim 1 wherein at least one of the first and second multiplier circuits comprises squaring and subtraction circuits configured for the generation of said first product signal.

5. (canceled)

6. The analog learning system according to claim 1 wherein at least one of the first and second multiplier circuits comprises a scaling circuit configured to factor out of the product signal thereby generated a scaling constant.

7. The analog learning system according to claim 1 wherein the output signal is a temporally integrated signal generated by the artificial neuron circuit, and wherein said artificial neuron circuit is configured to control at least one of a rise time, width, fall time, and refractory period, of output signals thereby generated.

8. (canceled)

9. The analog learning system according to claim 7 wherein the artificial neuron circuit comprises at least one of the following: a scaling input stage configured to receive one or more input signals and respective one or more scaling signals, at least one of said one or more scaling signals associated with a weight signal generated by the weight update circuit, adapt each of said input signals in accordance with its respective scaling signal, and generate an input current of said artificial neuron circuit based on the scaled input signals; a leaky integrate and fire (LIF) neuron circuit configured to generate spike signals based on the input current from the scaling input stage, said LIF neuron circuit comprising a soma module configured to regulate a leakage current used for charging a soma capacitive element thereof; a spike generator configured to generate first and second driving currents whenever a voltage over the soma capacitive element is greater than a defined voltage level, said first driving current used for charging the soma capacitive element, and said second driving current used for generating the spike signals, and wherein said analog signal processing circuit comprises a spike shaping module configured to: regulate a discharge current of said soma capacitive element, charge a spike shaping capacitive element thereof with the second driving current from the spike generator, and regulate the discharge current of the soma capacitive element according to a voltage level of said spike shaping capacitive element.

10.-15. (canceled)

16. The analog learning system according to claim 9 wherein the spike generator comprises first and second invertors, said second invertor configured to generate the second driving current, and to discharge the spike shaping capacitive element whenever the voltage over the soma capacitive element is smaller than the defined voltage level.

17. The analog signal processing circuit according to claim 9 comprising an integration module configured to regulate a charging current of an integration capacitive element thereof according to a voltage level over the spike shaping capacitive element, and output the temporally integrated signal based on a voltage level of said integration capacitive element.

18. (canceled)

19. A learning core usable for an artificial neuron network, said learning core comprising:
an artificial neuron circuit comprising: a scaling input circuit configured to receive one or more input signals, adapt at least one of said one or more input signals in accordance with a weight signal, and generate an input current of said artificial neuron circuit based at least on the adapted input signal; a leaky integrate and fire (LIF) neuron circuit configured to generate spike signals based on the input current from said scaling input circuit; and an integration circuit configured to generate a temporally integrated signal indicative of temporal integration of at least some of said spike signals; and
an analog signal processing circuit comprising: an input configured to adapt said temporally integrated signal in accordance with a predefined adaptation signal indicative of a learning rate of said artificial neuron circuit; a first multiplier circuit configured to generate a first product signal based on a multiplication of the adapted temporally integrated signal by a feedback signal of said artificial neuron circuit; a weight update circuit configured to generate a new weight signal based on a multiplication of a previous weight signal by a summation of said previous weight signal with said first product signal; and a second multiplier circuit configured to generate a second product signal based on a multiplication of said temporally integrated signal by the new weight signal.

20. The learning core according to claim 19 wherein the LIF neuron circuit comprises a soma module configured to regulate a leakage current from said scaling input circuit for adjusting a charging current of a soma capacitive element thereof.

21. The learning core according to claim 20 wherein the LIF neuron circuit comprises a spike generator configured to generate first and second driving currents whenever a voltage over the soma capacitive element is greater than a defined voltage level, said first driving current being used for charging the soma capacitive element, and said second driving current being used for generating the spike signals.

22. The learning core according to claim 21 comprising a spike shaping module configured to charge a spike shaping capacitive element thereof with the second driving current from the spike generator and regulate according to voltage level of said spike shaping capacitive element a discharge current of the soma capacitive element.

23. The learning core according to claim 22 wherein the spike generator comprises first and second invertors, said second invertor configured to generate the second driving current, and to discharge the spike shaping capacitive element whenever the voltage over the soma capacitive element is smaller than the defined voltage level, and wherein said learning core comprising an integration module configured to regulate a charging current of an integration capacitive element thereof according to a voltage level over the spike shaping capacitive element, wherein the temporally integrated signal is indicative of the voltage of said spike shaping capacitive element.

24. (canceled)

25. An artificial neural network comprising two or more of the learning cores according to claim 19, a summation circuit configured to generated a summation signal based on a summation of the second product signal from the analog signal processing circuits of said two or more of the learning cores, and a subtraction circuit configured generate the feedback signal for said learning core based on a subtraction of a reference signal from said summation signal.

26. A method of generating a signal component for a feedback signal of an artificial neuron, the method comprising generating a first product signal based on an output signal of said artificial neuron and a previously generated feedback signal of said artificial neuron, generating a new weight signal from a previously generated weight signal and a summation of said previously generated weight signal with said first product signal, and generating said signal component from a second product signal generated based on said output signal and said new weight signal.

27. The method according to claim 26 comprising scaling the output signal according to a predefined learning rate of the artificial neuron.

28. The method according to claim 26 comprising generating the output signal by adapting one or more input signals in accordance with at least one scaling signal, and generating an input current of the artificial neuron based on the adapted one or more input signals.

29. The method of claim 28 comprising generating spike signals by the artificial neuron based on the input current.

30. The method according to claim 29 comprising regulating a leakage current for adjusting the input current and charging a soma capacitive element.

31. The method according to claim 30 comprising one or more of the following: generating first and second driving currents whenever a voltage over the soma capacitive element is greater than a defined voltage level, and charging said soma capacitive element by said first driving current, and generating the spike signals by said second driving current; charging a spike shaping capacitive element by the second driving current and regulating according to a voltage level of said spike shaping capacitive element a discharge current of the soma capacitive element; discharging the spike shaping capacitive element whenever the voltage over the soma capacitive element is smaller than the defined voltage level value; regulating a charging current of an integration capacitive element according to a voltage level over the spike shaping capacitive element and outputting the temporally integrated signal based on a voltage level of said integration capacitive element.

32.-34. (canceled)
